(19) United States
(12) Patent Application Publication
(10) Pub. No.: US 2022/0214181 A1
(43) Pub. Date: Jul. 7, 2022

(54) SYSTEMS AND METHODS FOR TRANSLATING NAVIGATIONAL ROUTE INTO BEHAVIORAL DECISION MAKING IN AUTONOMOUS VEHICLES

(71) Applicant: GM GLOBAL TECHNOLOGY OPERATIONS LLC, Detroit, MI (US)

(72) Inventors: Sayyed Rouhollah Jafari Tafti, Troy, MI (US); Anthony L. Perez, Ann Arbor, MI (US); Roi Reshef, Herzliya (IL)

(73) Assignee: GM GLOBAL TECHNOLOGY OPERATIONS LLC, Detroit, MI (US)

(21) Appl. No.: 17/141,421

(22) Filed: Jan. 5, 2021

(51) Int. Cl. G01C 21/34; G01C 21/36; B60W 40/09; B60W 50/14

(52) U.S. Cl. CPC G01C 21/3453; G01C 21/3667; B60W 2556/50; B60W 50/14; B60W 2050/146; B60W 40/09

(57) ABSTRACT

Methods and apparatus are provided for behavior planning for an autonomous vehicle. In one embodiment, a method includes: receiving navigation data including a navigation route; converting the navigation route to road segment data including a plurality of road segments; assigning lane attributes to the plurality road segments of the road segment data; computing cost data for each of the road segments; evaluating the cost data of each of the road segments to determine at least one driving behavior; and generating a display signal for displaying the driving behavior to a user of the autonomous vehicle.

### INTRODUCTION

The present disclosure generally relates to autonomous vehicles, and more particularly relates to systems and methods for path planning in an autonomous vehicle.

An autonomous vehicle is a vehicle that is capable of sensing its environment and navigating with little or no user input. It does so by using sensing devices such as radar, lidar, image sensors, and the like. Autonomous vehicles further use information from global positioning systems (GPS) technology, navigation systems, vehicle-to-vehicle communication, vehicle-to-infrastructure technology, and/or drive-by-wire systems to navigate the vehicle.

While recent years have seen significant advancements in autonomous vehicles, such vehicles might still be improved in a number of respects. For example, it is often difficult for an autonomous vehicle to quickly determine a suitable path (along with target accelerations and velocities) to maneuver through a region of interest while avoiding obstacles whose paths might intersect with the region of interest within some predetermined planning horizon. Road-level navigation plans generated by standard infotainment systems do not provide enough detailed information for autonomous driving to path plan. Compressing long-term road-level plans into efficient and actionable conditions for short-term behavioral planning can be computationally intensive and time consuming.

Accordingly, it is desirable to provide improved methods and systems for behavioral planning for an autonomous vehicle. Furthermore, other desirable features and characteristics of the present invention will become apparent from the subsequent detailed description and the appended claims, taken in conjunction with the accompanying drawings and the foregoing technical field and background.

### SUMMARY

Methods and systems for behavior planning for an autonomous vehicle are provided. The planning system is effective in translating the navigation route into behavioral decision-making plans for autonomous vehicles. In one embodiment, a method includes: receiving navigation data including a navigation route; converting the navigation route to road segment data including a plurality of road segments; assigning lane attributes to the plurality road segments of the road segment data; computing cost data for each of the road segments; evaluating the cost data of each of the road segments to determine at least one driving behavior; and generating a display signal for displaying the driving behavior to a user of the autonomous vehicle.

In various embodiments, the cost data includes a lane occupancy cost. In various embodiments, the computing the lane occupancy cost is based on lane attributes from perception data, lane properties from map data, and lane segments in the current road segment.

In various embodiments, the cost data includes a lane end cost. In various embodiments, the computing the lane end cost is based on lane properties from map data, and downstream lane segments. In various embodiments, the computing the lane end cost comprises backpropagating the lane end cost from downstream road segments.

In various embodiments, the cost data includes a lane occupancy cost and a lane end cost. In various embodiments, the lane occupancy cost is computed as a binary value. In various embodiments, the lane occupancy cost is zero when the lane is drivable. In various embodiments, the lane end cost is zero when any downstream lanes have a lane occupancy cost of zero.

In another embodiment, a computer implemented system includes: a planner module that comprises one or more processors configured by programming instructions encoded in non-transitory computer readable media. The planner module is configured to: receive navigation data including a navigation route; convert the navigation route to road segment data including a plurality of road segments; assign lane attributes to the plurality road segments of the road segment data; compute cost data for each of the road segments; evaluate the cost data of each of the road segments to determine at least one driving behavior; and generate a display signal for displaying the driving behavior to a user of the autonomous vehicle.

In various embodiments, the cost data includes a lane occupancy cost. In various embodiments, wherein the planner module computes the lane occupancy cost based on lane attributes from perception data, lane properties from map data, and lane segments in the current road segment.

In various embodiments, the cost data includes a lane occupancy cost. In various embodiments, the planner module computes the lane occupancy cost based on lane properties from map data, and downstream lane segments. In various embodiments, the planner module computes the lane occupancy cost by backpropagating the lane end cost from downstream road segments.

In various embodiments, the cost data includes a lane occupancy cost and a lane end cost. In various embodiments, the lane occupancy cost is computed as a binary value. In various embodiments, wherein the lane occupancy cost is set to zero when the lane is drivable. In various embodiments, the lane end cost is set to zero when any downstream lanes have a lane occupancy cost of zero.

### DESCRIPTION OF THE DRAWINGS

The exemplary embodiments will hereinafter be described in conjunction with the following drawing figures, wherein like numerals denote like elements, and wherein:

FIG. 1 is a functional block diagram illustrating an autonomous vehicle including a path planning system, in accordance with various embodiments;

FIG. 2 is a functional block diagram illustrating a transportation system having one or more autonomous vehicles as shown in FIG. 1, in accordance with various embodiments;

FIG. 3 is functional block diagram illustrating an autonomous driving system (ADS) associated with an autonomous vehicle, in accordance with various embodiments;

FIG. 4 is a dataflow diagram illustrating a path planning system of an autonomous vehicle, in accordance with various embodiments;

FIG. 5 is an illustration of a route, and road segments of the path planning system in accordance with various embodiments; and

FIGS. 6 and 7 are flowcharts illustrating control methods for controlling the autonomous vehicle, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary, or the following detailed description. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, machine learning models, radar, lidar, image analysis, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

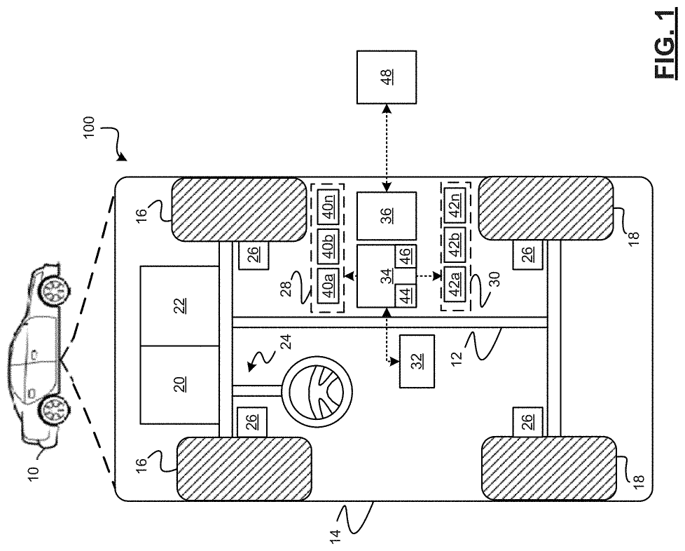

With reference to FIG. 1, a path planning system shown generally as 100 is associated with a vehicle (or “AV”) 10 in accordance with various embodiments. In general, path planning system (or simply “system”) 100 allows for selecting a path for AV 10 by using a cost-based route planner which provides lane-level information. The resulting route plans are efficient and actionable plans that enable short-term path planning. In various embodiments, the route plans extract the relevant long-term map/navigation information in a way that eases the optimization of decisions based on dynamic information, as will be discussed in more detail below.

As depicted in FIG. 1, the vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

In various embodiments, the vehicle 10 is an autonomous vehicle and the path planning system 100 is incorporated into the autonomous vehicle 10 (hereinafter referred to as the autonomous vehicle 10). The autonomous vehicle 10 is, for example, a vehicle that is automatically controlled to carry passengers from one location to another. The vehicle 10 is depicted in the illustrated embodiment as a passenger car, but it should be appreciated that any other vehicle, including motorcycles, trucks, sport utility vehicles (SUVs), recreational vehicles (RVs), marine vessels, aircraft, etc., can also be used.

In an exemplary embodiment, the autonomous vehicle 10 corresponds to a level four or level five automation system under the Society of Automotive Engineers (SAE) “J3016” standard taxonomy of automated driving levels. Using this terminology, a level four system indicates “high automation,” referring to a driving mode in which the automated driving system performs all aspects of the dynamic driving task, even if a human driver does not respond appropriately to a request to intervene. A level five system, on the other hand, indicates “full automation,” referring to a driving mode in which the automated driving system performs all aspects of the dynamic driving task under all roadway and environmental conditions that can be managed by a human driver. It will be appreciated, however, the embodiments in accordance with the present subject matter are not limited to any particular taxonomy or rubric of automation categories. Furthermore, systems in accordance with the present embodiment may be used in conjunction with any vehicle in which the present subject matter may be implemented, regardless of its level of autonomy.

As shown, the autonomous vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16 and 18 according to selectable speed ratios. According to various embodiments, the transmission system 22 may include a step-ratio automatic transmission, a continuously-variable transmission, or other appropriate transmission.

The brake system 26 is configured to provide braking torque to the vehicle wheels 16 and 18. Brake system 26 may, in various embodiments, include friction brakes, brake by wire, a regenerative braking system such as an electric machine, and/or other appropriate braking systems.

The steering system 24 influences a position of the vehicle wheels 16 and/or 18. While depicted as including a steering wheel 25 for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10 (such as the state of one or more occupants). Sensing devices 40a-40n might include, but are not limited to, radars (e.g., long-range, medium-range-short range), lidars, global positioning systems, optical cameras (e.g., forward facing, 360-degree, rear-facing, side-facing, stereo, etc.), thermal (e.g., infrared) cameras, ultrasonic sensors, odometry sensors (e.g., encoders) and/or other sensors that might be utilized in connection with systems and methods in accordance with the present subject matter.

The actuator system 30 includes one or more actuator devices 42a-42n that control one or more vehicle features such as, but not limited to, the propulsion system 20, the transmission system 22, the steering system 24, and the brake system 26. In various embodiments, autonomous vehicle 10 may also include interior and/or exterior vehicle features not illustrated in FIG. 1, such as various doors, a trunk, and cabin features such as air, music, lighting, touch-screen display components (such as those used in connection with navigation systems), and the like.

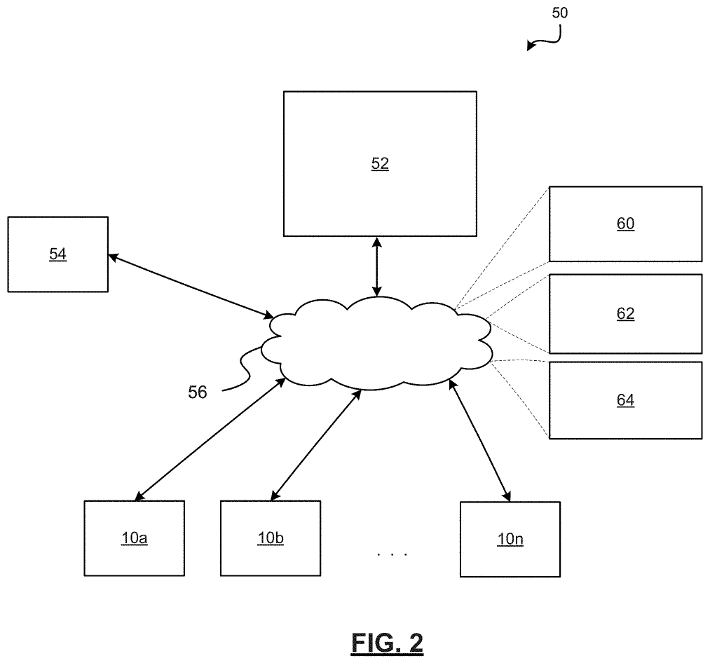

The data storage device 32 stores data for use in automatically controlling the autonomous vehicle 10. In various embodiments, the data storage device 32 stores defined maps of the navigable environment. In various embodiments, the defined maps may be predefined by and obtained from a remote system (described in further detail with regard to FIG. 2). For example, the defined maps may be assembled by the remote system and communicated to the autonomous vehicle 10 (wirelessly and/or in a wired manner) and stored in the data storage device 32. Route information may also be stored within data storage device 32—i.e., a set of road segments (associated geographically with one or more of the defined maps) that together define a route that the user may take to travel from a start location (e.g., the user's current location) to a target location. As will be appreciated, the data storage device 32 may be part of the controller 34, separate from the controller 34, or part of the controller 34 and part of a separate system.

The controller 34 includes at least one processor 44 and a computer-readable storage device or media 46. The processor 44 may be any custom-made or commercially available processor, a central processing unit (CPU), a graphics processing unit (GPU), an application specific integrated circuit (ASIC) (e.g., a custom ASIC implementing a neural network), a field programmable gate array (FPGA), an auxiliary processor among several processors associated with the controller 34, a semiconductor-based microprocessor (in the form of a microchip or chip set), any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10. In various embodiments, controller 34 is configured to implement the path planning systems and methods discussed in more detail below.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals that are transmitted to the actuator system 30 to automatically control the components of the autonomous vehicle 10 based on the logic, calculations, methods, and/or algorithms. Although only one controller 34 is shown in FIG. 1, embodiments of the autonomous vehicle 10 may include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

The communication system 36 is configured to wirelessly communicate information to and from other entities 48, such as but not limited to, other vehicles (“V2V” communication), infrastructure (“V2I” communication), networks (“V2N” communication), pedestrian (“V2P” communication), remote transportation systems, and/or user devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

With reference now to FIG. 2, in various embodiments, the autonomous vehicle 10 described with regard to FIG. 1 may be suitable for use in the context of a taxi or shuttle system in a certain geographical area (e.g., a city, a school or business campus, a shopping center, an amusement park, an event center, or the like) or may simply be managed by a remote system. For example, the autonomous vehicle 10 may be associated with an autonomous-vehicle-based remote transportation system. FIG. 2 illustrates an exemplary embodiment of an operating environment shown generally at 50 that includes an autonomous-vehicle-based remote transportation system (or simply “remote transportation system”) 52 that is associated with one or more autonomous vehicles 10a-10n as described with regard to FIG. 1. In various embodiments, the operating environment 50 (all or a part of which may correspond to entities 48 shown in FIG. 1) further includes one or more user devices 54 that communicate with the autonomous vehicle 10 and/or the remote transportation system 52 via a communication network 56.

The communication network 56 supports communication as needed between devices, systems, and components supported by the operating environment 50 (e.g., via tangible communication links and/or wireless communication links). For example, the communication network 56 may include a wireless carrier system 60 such as a cellular telephone system that includes a plurality of cell towers (not shown), one or more mobile switching centers (MSCs) (not shown), as well as any other networking components required to connect the wireless carrier system 60 with a land communications system. Each cell tower includes sending and receiving antennas and a base station, with the base stations from different cell towers being connected to the MSC either directly or via intermediary equipment such as a base station controller. The wireless carrier system 60 can implement any suitable communications technology, including for example, digital technologies such as CDMA (e.g., CDMA2000), LTE (e.g., 4G LTE or 5G LTE), GSM/GPRS, or other current or emerging wireless technologies. Other cell tower/base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from including the wireless carrier system 60, a second wireless carrier system in the form of a satellite communication system 64 can be included to provide uni-directional or bi-directional communication with the autonomous vehicles 10a-10n. This can be done using one or more communication satellites (not shown) and an uplink transmitting station (not shown). Uni-directional communication can include, for example, satellite radio services, wherein programming content (news, music, etc.) is received by the transmitting station, packaged for upload, and then sent to the satellite, which broadcasts the programming to subscribers. Bi-directional communication can include, for example, satellite telephony services using the satellite to relay telephone communications between the vehicle 10 and the station. The satellite telephony can be utilized either in addition to or in lieu of the wireless carrier system 60.

A land communication system 62 may further be included that is a conventional land-based telecommunications network connected to one or more landline telephones and connects the wireless carrier system 60 to the remote transportation system 52. For example, the land communication system 62 may include a public switched telephone network (PSTN) such as that used to provide hardwired telephony, packet-switched data communications, and the Internet infrastructure. One or more segments of the land communication system 62 can be implemented through the use of a standard wired network, a fiber or other optical network, a cable network, power lines, other wireless networks such as wireless local area networks (WLANs), or networks providing broadband wireless access (BWA), or any combination thereof. Furthermore, the remote transportation system 52 need not be connected via the land communication system 62, but can include wireless telephony equipment so that it can communicate directly with a wireless network, such as the wireless carrier system 60.

Although only one user device 54 is shown in FIG. 2, embodiments of the operating environment 50 can support any number of user devices 54, including multiple user devices 54 owned, operated, or otherwise used by one person. Each user device 54 supported by the operating environment 50 may be implemented using any suitable hardware platform. In this regard, the user device 54 can be realized in any common form factor including, but not limited to: a desktop computer; a mobile computer (e.g., a tablet computer, a laptop computer, or a netbook computer); a smartphone; a video game device; a digital media player; a component of a home entertainment equipment; a digital camera or video camera; a wearable computing device (e.g., smart watch, smart glasses, smart clothing); or the like. Each user device 54 supported by the operating environment 50 is realized as a computer-implemented or computer-based device having the hardware, software, firmware, and/or processing logic needed to carry out the various techniques and methodologies described herein. For example, the user device 54 includes a microprocessor in the form of a programmable device that includes one or more instructions stored in an internal memory structure and applied to receive binary input to create binary output. In some embodiments, the user device 54 includes a GPS module capable of receiving GPS satellite signals and generating GPS coordinates based on those signals. In other embodiments, the user device 54 includes cellular communications functionality such that the device carries out voice and/or data communications over the communication network 56 using one or more cellular communications protocols, as are discussed herein. In various embodiments, the user device 54 includes a visual display, such as a touch-screen graphical display, or other display.

The remote transportation system 52 includes one or more backend server systems, not shown), which may be cloud-based, network-based, or resident at the particular campus or geographical location serviced by the remote transportation system 52. The remote transportation system 52 can be manned by a live advisor, an automated advisor, an artificial intelligence system, or a combination thereof. The remote transportation system 52 can communicate with the user devices 54 and the autonomous vehicles 10a-10n to schedule rides, dispatch autonomous vehicles 10a-10n, and the like. In various embodiments, the remote transportation system 52 stores store account information such as subscriber authentication information, vehicle identifiers, profile records, biometric data, behavioral patterns, and other pertinent subscriber information.

In accordance with a typical use case workflow, a registered user of the remote transportation system 52 can create a ride request via the user device 54. The ride request will typically indicate the passenger's desired pickup location (or current GPS location), the desired destination location (which may identify a predefined vehicle stop and/or a user-specified passenger destination), and a pickup time. The remote transportation system 52 receives the ride request, processes the request, and dispatches a selected one of the autonomous vehicles 10a-10n (when and if one is available) to pick up the passenger at the designated pickup location and at the appropriate time. The transportation system 52 can also generate and send a suitably configured confirmation message or notification to the user device 54, to let the passenger know that a vehicle is on the way.

As can be appreciated, the subject matter disclosed herein provides certain enhanced features and functionality to what may be considered as a standard or baseline autonomous vehicle 10 and/or an autonomous vehicle based remote transportation system 52. To this end, an autonomous vehicle and autonomous vehicle based remote transportation system can be modified, enhanced, or otherwise supplemented to provide the additional features described in more detail below.

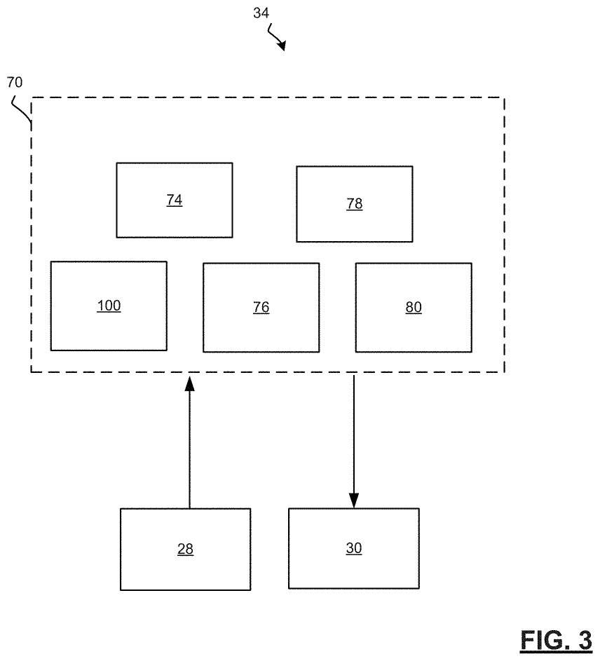

In accordance with various embodiments, controller 34 implements an autonomous driving system (ADS) 70 as shown in FIG. 3. That is, suitable software and/or hardware components of controller 34 (e.g., processor 44 and computer-readable storage device 46) are utilized to provide an autonomous driving system 70 that is used in conjunction with vehicle 10.

In various embodiments, the instructions of the autonomous driving system 70 may be organized by function or system. For example, as shown in FIG. 3, the autonomous driving system 70 can include a computer vision system 74, a positioning system 76, a guidance system 78, and a vehicle control system 80. As can be appreciated, in various embodiments, the instructions may be organized into any number of systems (e.g., combined, further partitioned, etc.) as the disclosure is not limited to the present examples.

In various embodiments, the computer vision system 74 synthesizes and processes sensor data and predicts the presence, location, classification, and/or path of objects and features of the environment of the vehicle 10. In various embodiments, the computer vision system 74 can incorporate information from multiple sensors (e.g., sensor system 28), including but not limited to cameras, lidars, radars, and/or any number of other types of sensors.

The positioning system 76 processes sensor data along with other data to determine a position (e.g., a local position relative to a map, an exact position relative to a lane of a road, a vehicle heading, etc.) of the vehicle 10 relative to the environment. As can be appreciated, a variety of techniques may be employed to accomplish this localization, including, for example, simultaneous localization and mapping (SLAM), particle filters, Kalman filters, Bayesian filters, and the like.

The guidance system 78 processes sensor data along with other data to determine a path for the vehicle 10 to follow. The vehicle control system 80 generates control signals for controlling the vehicle 10 according to the determined path.

In various embodiments, the controller 34 implements machine learning techniques to assist the functionality of the controller 34, such as feature detection/classification, obstruction mitigation, route traversal, mapping, sensor integration, ground-truth determination, and the like.

In various embodiments, all or parts of the path planning system 100 may be included within the computer vision system 74, the positioning system 76, the guidance system 78, and/or the vehicle control system 80. As mentioned briefly above, the path planning system 100 of FIG. 1 is configured to determine paths using a road-level route with map-based lane connectivity and attributes to generate lane-level information to enable autonomous vehicle path planning. In various embodiments, the lane-level information is represented in terms of two cost components: lane occupancy cost and lane end cost. Using this approach, downstream behavioral planning logic is only required to optimize for driving decisions within the perceived horizon (a single to few road segments ahead).

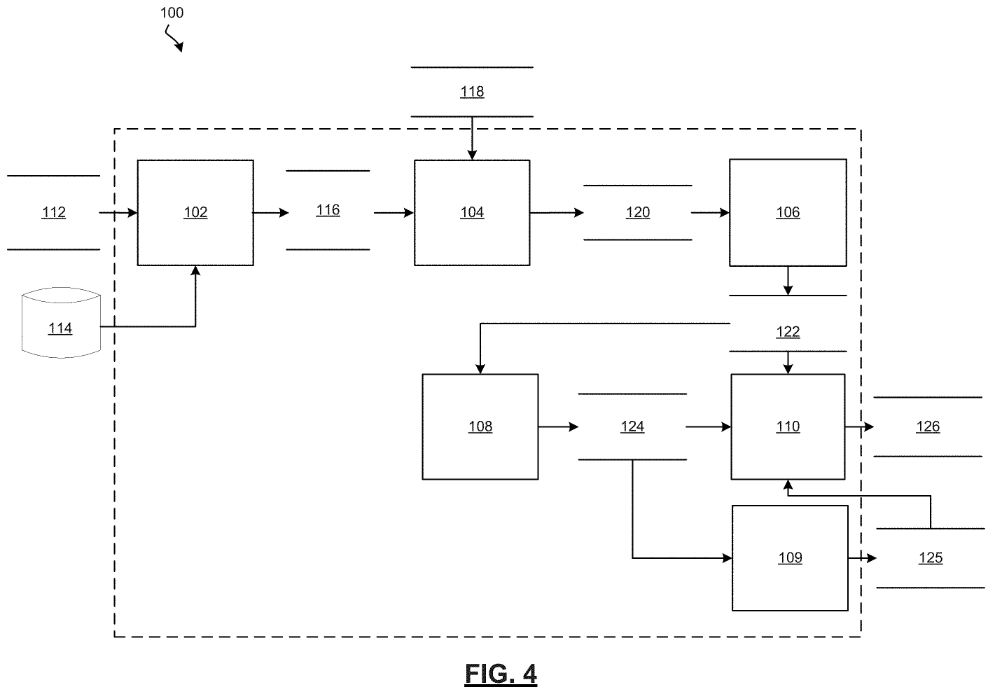

With reference now to FIG. 4, a dataflow diagram illustrates all or parts of the path planning system 100 in accordance with various embodiments. It will be understood that various embodiments of the path planning system 100 according to the present disclosure may include any number of sub-modules embedded within the controller 34 which may be combined and/or further partitioned to similarly implement systems and methods described herein. Furthermore, inputs to the path planning system 100 may be received from the sensor system 28, received from other control modules (not shown) associated with the autonomous vehicle 10, received from the communication system 36, and/or determined/modeled by other sub-modules (not shown) within the controller 34 of FIG. 1. Furthermore, the inputs might also be subjected to preprocessing, such as sub-sampling, noise-reduction, normalization, feature-extraction, missing data reduction, and the like. In various embodiments, the path planning system 100 includes a navigation planner module 102, a scene provider module 104, a route planner module 106, a behavior planner module 108, a trajectory planner module 109, and a visualizer module 110.

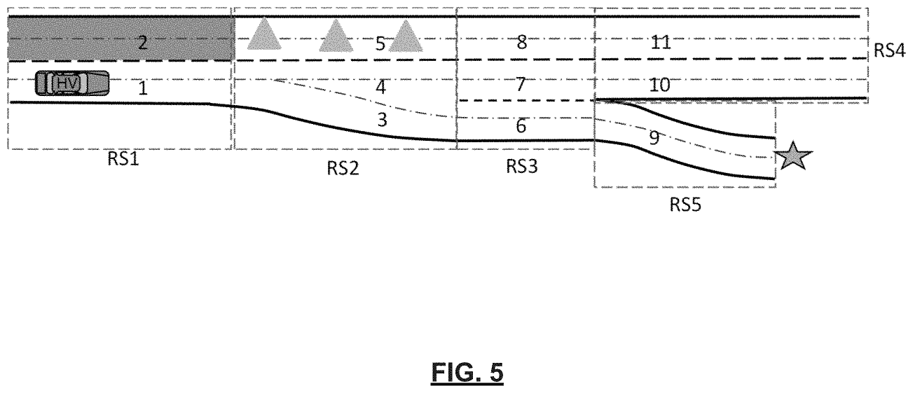

In various embodiments, the navigation planner module 102 receives as input navigation data 112. The navigation data 112 may be generated by a navigation system and includes a desired route of the vehicle 10. The navigation planner module 102 converts the navigation route to road-level route information based on map data from a map datastore 114 of the vehicle 10 and generates road properties data 116 based thereon. As shown in FIG. 5, the navigation planner module 102 generates ordered sequences of road segment IDs (RS1, RS2, RS3, RS5) along the planned route within a horizon ahead of the vehicle 10 and associates properties of the road (e.g., the type of road, the number of lanes, the type of lanes, the speed limit, planned lane closures or construction zones, lanes in direction or in opposite direction to route, etc. identified by the map datastore 114) with each of the segments.

In various embodiments, the scene provider module 104 receives the road properties data 116, and perception data 118. The perception data 118 can include static and/or dynamic information perceived (e.g., from the sensor system) about the lanes such as objects within or near the lane, lane markings, lane types, construction status, lanes in direction of route, congestion level, lanes in opposite direction to route, etc. The scene provider module 104 updates the road properties data 116 based on the perception data 118 to produce lane attributes data 120.

In various embodiments, the route planner module 106 receives the lane attributes data 120. The route planner module 106 computes cost data 122 for each lane segment based on the lane attributes data 120. For example, in various embodiments, the route planner module 106 computes a lane occupancy cost (LOC) as a cost of occupying a lane segment and computes a lane end cost (LEC) as a cost of reaching the end of the lane segment.

In various embodiments, the LOC is computed based on the lane attributes (LA) and the lane end cost (LEC) for all lanes within the current road segment. For example, lane occupancy cost for i-th lane segment, LOCᵢ can be computed as:

LOCᵢ=f₁(LAᵢ)+f₂(LEC_{j=1:n})γ^{f}^{₃}^{(LP}^{ᵢ}⁾, (1)

where LAᵢ represents lane attributes for the i-th lane segment, LPᵢ represents the lane property for i-th lane segment, j=1:n represents the lane segments in the current road segment, γ represents a discount factor, and f₁, f₂ and f₃ represent the cost functions.

In various embodiments, the LEC is computed based on the LOC and LEC of the downstream lane segments. For example, the lane end cost for i-th lane segment, LECᵢ can be computed as:

$${LEC}_{i} = {min}_{\{ k = 1 \text{:} m \}} [ {g}_{1} ( {LEC}_{k} ) {γ}_{1}^{{g}_{2} ( {LP}_{i} )} + {g}_{3} ( {LOC}_{k} ) * {γ}_{2}^{{g}_{4} ( {LP}_{i} )} ] , \qquad ( 2 )$$

where LPᵢ represents the lane property for i-th lane segment, k=1:m represents the downstream lanes to the i-th lane segment, γ₁ and γ₂ represent discount factors, and g₂, g₃ and g₄ represent the cost functions.

Since the LEC calculation uses the cost data from the downstream road segments, the route planner module starts the calculation of the LEC and LOC from the last road segment in the road segment sequence provided by the navigation planner, e.g., RS5 in FIG. 5. Once done, it will continue backward in the route segment sequence to find LEC and LOC for next road segment, e.g., RS3 in FIG. 5.

In various embodiments, in addition to LOC consideration, downstream LEC is backpropagated as a function of estimated time to arrival. For example, the LECi can be computed as:

$${LEC}_{i} = \{ \begin{matrix}1 & if {LOC}_{i} = 1 or ( {LOC}_{j} = 1 for all j = 1 \text{:} n ) \\ {min}_{\{ j = 1 \text{:} n \}} ( {LEC}_{j} * {γ}^{\frac{{lane \_ length}_{j}}{{speed \_ limi t}_{j}}} ) & otherwise\end{matrix} \qquad ( 3 )$$

where j=1: n represents all downstream lanes to the current lane i, and γ represents the discount factor in backpropagation.

In various embodiments, the route planner module 106 computes the LOC and the LEC as binary values. For example, the LOC can be set equal to zero if the lane is drivable, otherwise the LOC can be set to one. In another example, the LEC can be set equal to zero when any downstream lanes have a LOC of zero, otherwise the LEC can be set equal to one.

In various embodiments, the behavior planner module 108 receives as input the cost data 122 including LOC data and LEC data. The behavior planner module 108 uses the cost data 122 and the other dynamic data from the perception system to generate a behavioral plan and updates behavior plan data 124 based thereon. For example, when all lane end costs are equal to one, a takeover flag may be set to TRUE. Otherwise the takeover flag may set to FLASE. As can be appreciated, other behavior planning can be implemented by the behavior planner module 108 in various embodiments.

In various embodiments, the trajectory planner module 109 receives as input the behavior plan data 124. The trajectory planner module 109 generates trajectory data 125 for controlling future motion of the vehicle 10 based on the behavior plan data 124 and/or other data.

In various embodiments, the visualizer module 110 receives as input the cost data, the behavior data 124, and/or the trajectory data 125. The visualizer module 110 generates display data 126 based on the received input data to display the plan including the lane level route on a display of the vehicle 10, for example, to be viewed by a user of the vehicle 10.

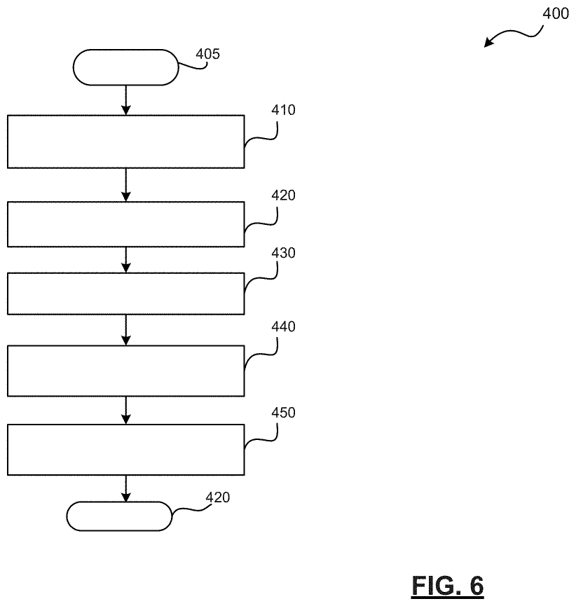

With reference now to FIG. 6, and with continued reference to FIGS. 1-5, a flowchart illustrates a method 400 that may be performed by the path planning system 100 in accordance with various embodiments. As can be appreciated in light of the disclosure, the order of operation within the method is not limited to the sequential execution as illustrated in FIG. 6, but may be performed in one or more varying orders as applicable and in accordance with the present disclosure. As can further be appreciated, one or more steps of the methods may be added or removed without altering the spirit of the method.

In one example, the method 400 may begin at 405. A navigation route is received and converted to road-level route information including road segments based on the internal map database at 410. The lane level attributes are determined and assigned to the road segments at 420.

Thereafter, the LEC and LOC are computed for each of the road segments using back propagation at 430. The LEC and LOC are evaluated to determine driving behaviors a t440. The event planning outputs are converted to trajectory data to control the vehicle and display signals to display to a user of the vehicle 10 at 450. Thereafter, the method may end at 460.

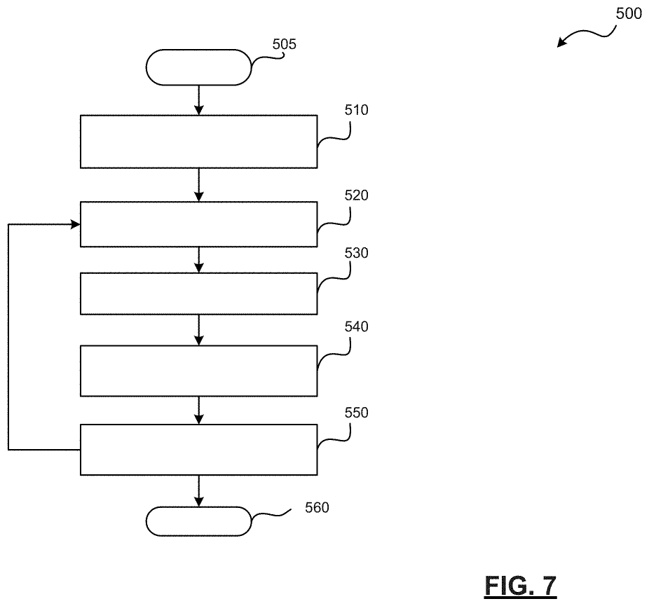

With reference now to FIG. 7, and with continued reference to FIGS. 1-5, a flowchart illustrates a method 500 that may be performed by the path planning system 100 in accordance with various embodiments. As can be appreciated in light of the disclosure, the order of operation within the method is not limited to the sequential execution as illustrated in FIG. 7 but may be performed in one or more varying orders as applicable and in accordance with the present disclosure. As can further be appreciated, one or more steps of the methods may be added or removed without altering the spirit of the method. The method illustrates a more detailed embodiment of step 430 of computing the LEC and LOC.

In one example, the method 500 may begin at 505. The last road segment in the navigation route sequence is selected at 510. The lane properties and attributes data are determined for the last road segment at 520. The LEC is computed for all lane segments in the selected road segment using, for example, equation (2) at 530. The LOC is computed for all lane segments in the selected road segment using, for example, equation (1) at 540. The next previous road segment in the navigation planner's road segment sequence is selected at 550. The backpropagation is performed to compute the cost data from the downstream road segment to the first road segment is performed for all road segments in the sequence at 520-540. Once all road segments have been processed at 550, the method may end at 560.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of behavior planning for an autonomous vehicle, comprising:
receiving navigation data including a navigation route;
converting the navigation route to road segment data including a plurality of road segments;
assigning lane attributes to the plurality road segments of the road segment data;
computing cost data for each of the road segments;
evaluating the cost data of each of the road segments to determine at least one driving behavior; and
generating a display signal for displaying the driving behavior to a user of the autonomous vehicle.

2. The method of claim 1, wherein the cost data includes a lane occupancy cost.

3. The method of claim 2, wherein the computing the lane occupancy cost is based on lane attributes from perception data, lane properties from map data, and lane segments in the current road segment.

4. The method of claim 1, wherein the cost data includes a lane end cost.

5. The method of claim 4, wherein the computing the lane end cost is based on lane properties from map data, and downstream lane segments.

6. The method of claim 4, wherein the computing the lane end cost comprises backpropagating the lane end cost from downstream road segments.

7. The method of claim 1, wherein the cost data includes a lane occupancy cost and a lane end cost.

8. The method of claim 7, wherein the lane occupancy cost is computed as a binary value.

9. The method of claim 8, wherein the lane occupancy cost is zero when a lane is drivable.

10. The method of claim 8, wherein the lane end cost is zero when any downstream lanes have a lane occupancy cost of zero.

11. A computer implemented system for planning behavior of an autonomous vehicle, comprising:
a planner module that comprises one or more processors configured by programming instructions encoded in non-transitory computer readable media, the planner module configured to:
receive navigation data including a navigation route;
convert the navigation route to road segment data including a plurality of road segments;
assign lane attributes to the plurality road segments of the road segment data;
compute cost data for each of the road segments;
evaluate the cost data of each of the road segments to determine at least one driving behavior; and
generate a display signal for displaying the at least one driving behavior to a user of the autonomous vehicle.

12. The computer implemented system of claim 11, wherein the cost data includes a lane occupancy cost.

13. The computer implemented system of claim 12, wherein the planner module computes the lane occupancy cost based on lane attributes from perception data, lane properties from map data, and lane segments in the current road segment.

14. The computer implemented system of claim 11, wherein the cost data includes a lane occupancy cost.

15. The computer implemented system of claim 14, wherein the planner module computes the lane occupancy cost based on lane properties from map data, and downstream lane segments.

16. The computer implemented system of claim 12, wherein the planner module computes the lane occupancy cost by backpropagating the lane end cost from downstream road segments.

17. The computer implemented system of claim 11, wherein the cost data includes a lane occupancy cost and a lane end cost.

18. The computer implemented system of claim 17, wherein the lane occupancy cost is computed as a binary value.

19. The computer implemented system of claim 18, wherein the lane occupancy cost is set to zero when a lane is drivable.

20. The computer implemented system of claim 18, wherein the lane end cost is set to zero when any downstream lanes have a lane occupancy cost of zero.
